(19) United States
(12) Patent Application Publication
(10) Pub. No.: US 2026/0298834 A1
(43) Pub. Date: Oct. 1, 2026

(54) VACUUM ENVIRONMENT OPTICAL INSPECTION SYSTEM

(71) Applicant: Sky-EUV Inc., HSINCHU COUNTY (TW)

(72) Inventor: PO-YAO HUANG, HSINCHU COUNTY (TW)

(21) Appl. No.: 19/574,488

(22) Filed: Mar. 23, 2026

(30) Foreign Application Priority Data
Mar. 31, 2025 (TW) 114112322

(51) Int. Cl. G01N 21/88; G01N 21/95

(52) U.S. Cl. CPC G01N 21/8806; G01N 21/9501; G01N 2201/06113

(57) ABSTRACT

A vacuum environment optical inspection system, used for optically inspecting a to-be-inspected object, includes a housing, a first rotating device, a second rotating device, a reflecting device, and an inspection device. The housing is vacuum. The first rotating device is disposed in the housing and controls the position of the to-be-inspected object. The second rotating device is disposed in the housing and controls the position of the reflecting device. The inspection device is disposed outside the housing. An inspection light in the housing is reflected by the to-be-inspected object the reflection device, and then output to the inspection device for inspection of the object. Through the cooperative arrangement of the devices, requirement of expensive optical inspection equipment within the vacuum environment is reduced, thereby reducing system installation costs and maintenance costs.

### BACKGROUND OF THE DISCLOSURE

### 1. Field of the Disclosure

The present disclosure relates to inspection systems, and more particularly, to a vacuum environment optical inspection system.

### 2. Description of the Related Art

In field of photolithography technology, extreme ultraviolet (EUV) light is typically used to perform a series of process steps (such as exposure, development, and etching) on a wafer. Semiconductor devices completed through an EUV process can only be optically inspected using EUV light in order to confirm the accuracy of inspection results. Since EUV light has an extremely short penetration depth (within a range of several nanometers to tens of nanometers), it is rapidly absorbed at the surface and within the bulk of a material. Therefore, it is critical to effectively measure the reflectivity of various semiconductor materials to EUV light through an optical camera.

Further, as the rotation angle (Δθ) of a sample material changes, the angle of reflected light changes by 2Δθ. The inspection system must guide the reflected light into an image of an optical camera in order to calculate the reflectivity of the sample material. Currently, two primary inspection technologies are known as follows.

The first method is to move the optical camera according to the angular change of the reflected light. The advantage of this approach lies in that the position of a light spot on a photosensitive element remains unchanged, thereby avoiding an intensity deviation caused by the light spot falling on different positions. However, such a method requires a mechanism capable of moving the optical camera according to the angle of the reflected light, and the optical camera has to be disposed within a vacuum. The mechanism capable of rotating the optical camera and the chamber that encloses the entire camera inevitably result in a bulky structure and high development costs. In addition, the weight of the optical camera may cause stress deformation of a moving track over time, thereby increasing the burden of routine maintenance and servicing.

The second method is to use an optical camera with a larger numerical aperture. Such a method uses an optical camera having a larger photosensitive element so as to capture the reflected light within a certain angular range without moving the optical camera. This method avoids the need of designing a large mechanism. However, when a light spot falls on different positions of the photosensitive element, light having the same intensity may appear with different intensities in an image, thereby introducing variables into measurement results. In addition, an optical camera having a larger numerical aperture is relatively costly, and its measurement range is limited by the aperture, thereby reducing the capturable angular range.

### SUMMARY OF THE DISCLOSURE

The present disclosure aims to improve the issues of excessive installation space requirement, high maintenance costs, and insufficient measurement accuracy associated with conventional inspection systems.

For achieving the aforementioned objectives, an embodiment of the present disclosure provides a vacuum environment optical inspection system for optically inspecting a to-be-inspected object, the vacuum environment optical inspection system comprising:

a housing having a vacuum inspection space and a light output hole, the light output hole penetrating a periphery of the housing and in communication with the vacuum inspection space, an inspection light being output through the light output hole after completing light path transmission within the vacuum inspection space;

a first rotating device disposed in the vacuum inspection space, the first rotating device being configured to carry and rotate the to-be-inspected object, the inspection light being projected onto the to-be-inspected object and reflected therefrom;

a second rotating device disposed in the vacuum inspection space;

a reflecting device connected to the second rotating device and configured to rotate about the to-be-inspected object to receive the inspection light reflected from the to-be-inspected object, and to further reflect the inspection light toward the light output hole along an axial direction of the light output hole; and

an inspection device disposed outside the housing and in alignment with the axial direction of the light output hole to receive the inspection light reflected by the reflecting device.

Also, another embodiment of the present disclosure provides a vacuum environment optical inspection system for optically inspecting a to-be-inspected object, the vacuum environment optical inspection system comprising:

a vacuum rotating housing having a first housing portion, a connecting portion, and a second housing portion, the connecting portion connected between the first housing portion and the second housing portion and forming a vacuum inspection space, the first housing portion and the second housing portion being configured to be relatively rotatable via the connecting portion, a light output hole penetrating a periphery of the first housing portion, an inspection light being generated within the vacuum inspection space and projected onto the to-be-inspected object located in the vacuum inspection space;

a first rotating device connected to the second housing portion and disposed in the vacuum inspection space, the first rotating device being configured to carry and rotate the to-be-inspected object;

a reflecting device disposed in the vacuum inspection space and connected to the first housing portion, the reflecting device being configured to receive the inspection light reflected from the to-be-inspected object and to further reflect the inspection light toward the light output hole along an axial direction of the light output hole; and

an inspection device disposed outside the first housing portion and in alignment with the axial direction of the light output hole to receive the inspection light reflected by the reflecting device.

With such configuration, by the cooperative arrangement of the first rotating device, the second rotating device, and the reflecting device, the present disclosure precisely controls the light path of the inspection light and unifies the output position of the inspection light, such that the installation position of the inspection device is able to be fixed and disposed outside the vacuum inspection space, enabling a significant reduction of the vacuum inspection space and the installation cost of the inspection device while maintaining the high-precision inspection, thereby achieving a reduction in the overall system installation and maintenance costs.

### BRIEF DESCRIPTION OF THE DRAWINGS

FIG. 1 is a partially sectional perspective view of a vacuum environment optical inspection system in accordance with the first embodiment of the present disclosure.

FIG. 2 is a partially sectional perspective view of a vacuum environment optical inspection system in accordance with the first embodiment of the present disclosure, illustrating the first rotating device and the second rotating device being relatively rotatable.

FIG. 3 is a partially sectional perspective view of a vacuum environment optical inspection system in accordance with another embodiment of the present disclosure.

FIG. 4 is a partially sectional perspective view of a vacuum environment optical inspection system in accordance with another embodiment of the present disclosure.

FIG. 5 is a partially sectional perspective view of a vacuum environment optical inspection system in accordance with the second embodiment of the present disclosure.

FIG. 6 is a partially sectional perspective view of a vacuum environment optical inspection system in accordance with the second embodiment of the present disclosure, illustrating the first rotating device and the first housing portion being rotatable.

FIG. 7 is a partially sectional perspective view of a vacuum environment optical inspection system in accordance with another embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

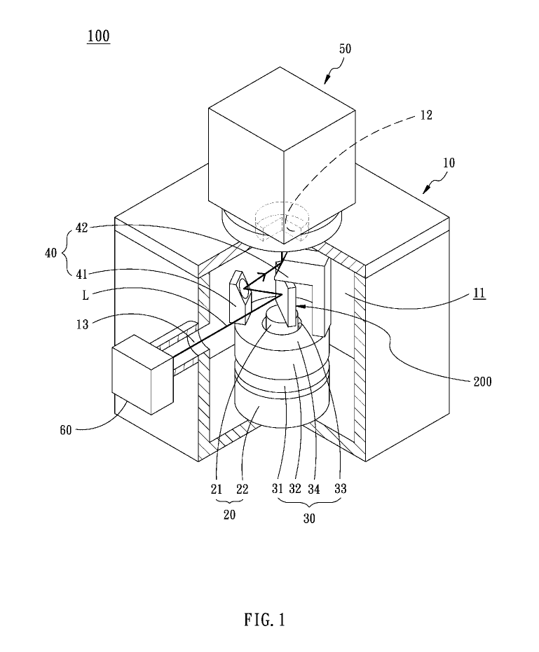

Referring to FIGS. 1-4, a vacuum environment optical inspection system 100 in accordance with the first embodiment of the present disclosure is illustrated. The vacuum environment optical inspection system 100 is configured to optically inspect a to-be-inspected object 200. The vacuum environment optical inspection system 100 comprises a housing 10, a first rotating device 20, a second rotating device 30, a reflecting device 40, and an inspection device 50.

In the embodiment, the housing 10 has a vacuum inspection space 11 and a light output hole 12. The light output hole 12 penetrates a periphery of the housing 10 and is in communication with the vacuum inspection space 11. An inspection light L is output through the light output hole 12 after completing light path transmission within the vacuum inspection space 11.

The first rotating device 20 is disposed in the vacuum inspection space 11. The first rotating device 20 is configured to carry and rotate the to-be-inspected object 200. The inspection light L is projected onto the to-be-inspected object 200 and reflected therefrom.

The second rotating device 30 is disposed in the vacuum inspection space 11. Referring to FIG. 1, in the first embodiment, the second rotating device 30 is coaxially stacked on the first rotating device 20 and is able to rotate independently or together with the first rotating device 20. However, the present disclosure is not limited thereto. In another embodiment, the second rotating device 30 may also be separate from and operate independently of the first rotating device 20.

Further, the reflecting device 40 is connected to the second rotating device 30 and rotates about the to-be-inspected object 200, so as to receive the inspection light L reflected from the to-be-inspected object 200 and further reflect the inspection light L toward the light output hole 12 along an axial direction of the light output hole 12.

The inspection device 50 is disposed outside the housing 10 and in alignment with the axial direction of the light output hole 12, so as to receive the inspection light L reflected by the reflecting device 40. Therein, the inspection device 50 may be hermetically mounted to the light output hole 12 via a hermetic connecting device (such as a flange), thereby maintaining the vacuum environment of the vacuum inspection space 11.

Referring to FIG. 1, in the first embodiment, the inspection light L is an extreme ultraviolet (EUV) light. A light input hole 13 penetrates the periphery of the housing 10 and is in communication with the vacuum inspection space 11, and a laser device 60 for generating the inspection light L is disposed outside the housing 10 and in alignment with the light input hole 13. The inspection light L passes through the light input hole 13 into the vacuum inspection space 11 and is projected onto the to-be-inspected object 200. Accordingly, the laser device 60 disposed outside the housing 10 facilitates adjustment and maintenance carried out by the user. Therein, the inspection light L may also be visible light, infrared light, X-rays, ultraviolet (UV) light, or other light suitable for optical inspection. The laser device 60 is configured to be hermetically connected to the light input hole 13 via a hermetic connecting device (such as a flange), thereby maintaining the vacuum environment of the vacuum inspection space 11.

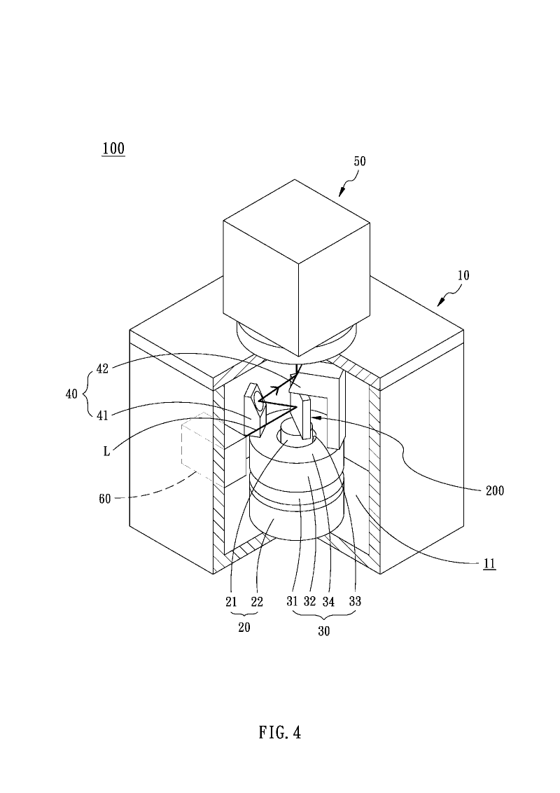

Referring to FIG. 4, in another embodiment, the laser device 60 generating the inspection light L is disposed in the vacuum inspection space 11 or in another vacuum space in communication with the vacuum inspection space 11. The inspection light L output by the laser device 60 is directly projected onto the to-be-inspected object 200 without the arrangement of the light input hole 13.

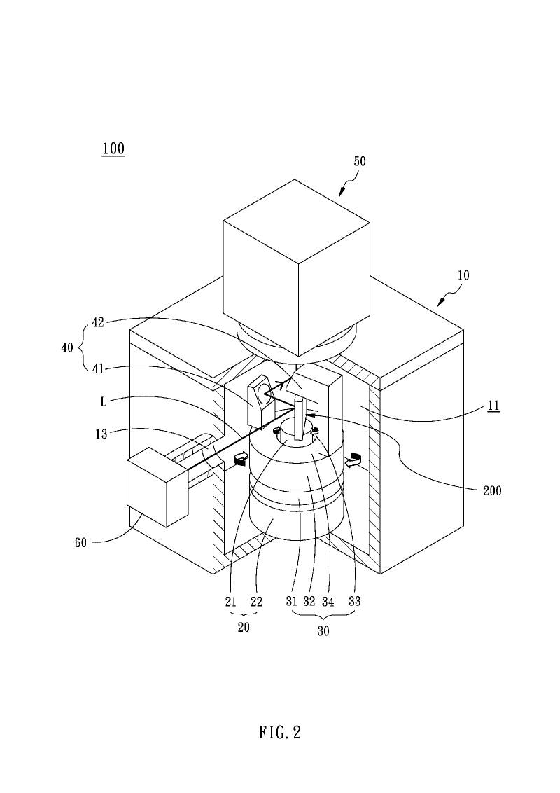

Referring to FIGS. 1 and 2, in the first embodiment, the first rotating device 20 comprises a carrier 21 and a first rotating member 22. The carrier 21 is connected and disposed at the center of the first rotating member 22, and the carrier 21 is configured to carry the to-be-inspected object 200. The first rotating member 22 is configured to drive the carrier 21 to rotate. Specifically, the first rotating member 22 is used to rotate the carrier 21 so as to correspondingly rotate the to-be-inspected object 200, such that the inspection light L is projected onto the to-be-inspected object 200 at different incident angles while maintaining a fixed incident position. Therefore, the inspection device 50 is able to obtain multiple sets of inspection data at different angles for the same inspection region of the to-be-inspected object 200 and accordingly perform the analysis, so as to obtain complete inspection information of the to-be-inspected object 200 of the aforementioned inspection region.

In addition, by directly moving the to-be-inspected object 200 or adjusting the overall position of the first rotating device 20, the inspection light L can be projected onto different inspection regions of the to-be-inspected object 200, thereby enabling the inspection device 50 to obtain inspection data of the to-be-inspected object 200 at different inspection regions.

In the first embodiment, the second rotating device 30, which is coaxially stacked on the first rotating device 20, comprises a coupling member 31, a second rotating member 32, and a mounting hole 33. The coupling member 31 is disposed between the second rotating member 32 and the first rotating member 22, such that the first rotating member 22 and the second rotating member 32 are rotatable relative to each other via the coupling member 31. The mounting hole 33 penetrates the center of the coupling member 31 and the second rotating member 32 and enables the carrier 21 to pass therethrough. Accordingly, through the arrangement of the coupling member 31, the second rotating member 32 and the first rotating member 22 are able to perform independent rotational motions without interfering with each other, thereby enabling the second rotating device 30 to be stacked on the first rotating device 20, saving the installation space requirement.

Referring to FIGS. 1 and 2, in the first embodiment, the reflecting device 40 is disposed on a supporting surface 34 of the second rotating device 30. Accordingly, when the to-be-inspected object 200 is rotated or moved, the position of the reflecting device 40 is configured to be correspondingly adjusted through the rotation of the second rotating device 30, such that the reflecting device 40 is able to correctly receive the inspection light L reflected from the to-be-inspected object 200 and further accurately reflect the inspection light L to the light output hole 12.

It should be noted that, during actual operation of the present disclosure, the rotation angle of the second rotating member 32 is twice the rotation angle of the first rotating member 22. For example, when the first rotating member 22 rotates by two degrees, the second rotating member 32 rotates by four degrees. Accordingly, the reflecting device 40 is able to accurately receive the inspection light L reflected from the to-be-inspected object 200 and further accurately reflect the inspection light L to the inspection device 50.

In addition, in another embodiment, the reflecting device 40 comprises a first reflecting member 41 and a second reflecting member 42. The first reflecting member 41 and the second reflecting member 42 are respectively disposed on two sides of the supporting surface 34. The first reflecting member 41 is configured to receive the inspection light L reflected from the to-be-inspected object 200 and further reflect the inspection light L to the second reflecting member 42. The second reflecting member 42 is configured to receive the inspection light L reflected from the first reflecting member 41 and further reflect the inspection light L toward the light output hole 12 along the axial direction of the light output hole 12. Through the arrangement of the first reflecting member 41 and the second reflecting member 42, the inspection light L is correctly reflected to the inspection device 50. Further, since the inspection device 50 is disposed in alignment with the axial direction of the light output hole 12, the configuration of the second reflecting member 42 reflecting the inspection light L along the axial direction of the light output hole 12 enables the inspection light L to be output to the inspection device 50 with minimal loss, thereby maintaining high inspection accuracy of the to-be-inspected object 200.

It should be noted that, in an embodiment, the light output hole 12 and the inspection device 50 are disposed directly above the to-be-inspected object 200, and the second reflecting member 42 is configured to reflect the inspection light L to the inspection device 50 along a vertical direction perpendicular to the ground surface. Accordingly, the inspection light L is reflected to the inspection device 50 along the shortest path, thereby maintaining the high inspection accuracy of the to-be-inspected object 200.

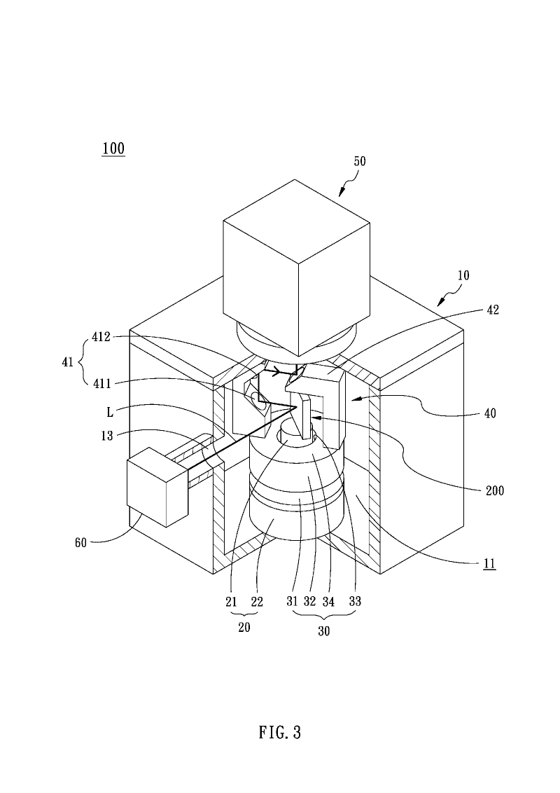

Referring to FIG. 3, in the embodiment, the first reflecting member 41 comprises a first reflecting portion 411 and a specular reflecting portion 412, which are symmetrically disposed. The specular reflecting portion 412 has the same specifications as the first reflecting portion 411 (such as both being a 45-degree mirror). The inspection light L reflected from the to-be-inspected object 200 is further reflected by the first reflecting portion 411 and the specular reflecting portion 412 along the respective reflection paths and then projected onto the second reflecting member 42. Accordingly, through the aforementioned symmetrical configuration, reflecting elements of the first reflecting portion 411 and the specular reflecting portion 412 can be selected to have identical specifications, thereby effectively simplifying the overall system parameter settings and reducing setup costs thereof. Furthermore, through the aforementioned symmetrical configuration, reflecting elements of the second reflecting member 42 can be selected to have identical specifications as those of the first reflecting portion 411 and the specular reflecting portion 412, thereby further reducing the setup complexity and setup costs. Therein, the travel paths of the inspection light L through the first reflecting portion 411, the specular reflecting portion 412, and the second reflecting member 42 are all perpendicularly paths.

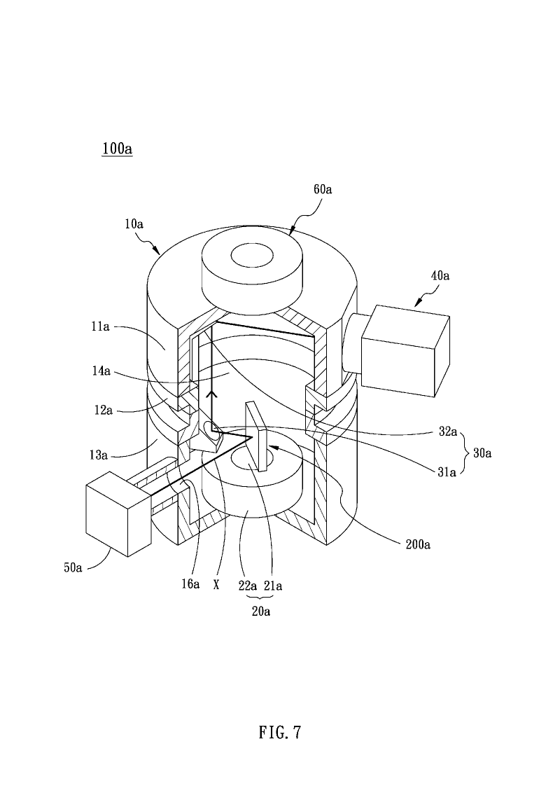

Referring to FIGS. 5-7, a vacuum environment optical inspection system 100a according to the second embodiment of the present disclosure is illustrated. The vacuum environment optical inspection system 100a is configured to optically inspect a to-be-inspected object 200a. The vacuum environment optical inspection system 100a comprises a vacuum rotating housing 10a, a first rotating device 20a, a reflecting device 30a, and an inspection device 40a.

The vacuum rotating housing 10a has a first housing portion 11a, a connecting portion 12a, and a second housing portion 13a. The connecting portion 12a is connected between the first housing portion 11a and the second housing portion 13a, and forms a vacuum inspection space 14a. The first housing portion 11a and the second housing portion 13a are configured to rotate relative to each other via the connecting portion 12a. A light output hole 15 a penetrates the periphery of the first housing portion 11a, and an inspection light X is generated within the vacuum inspection space 14a and projected onto the to-be-inspected object 200a located in the vacuum inspection space 14a. Therein, the first housing portion 11a, the connecting portion 12a, and the second housing portion 13a are all hermetically connected, thereby maintaining the vacuum environment of the vacuum inspection space 14a.

The first rotating device 20 a is connected to the second housing portion 13a and disposed in the vacuum inspection space 14a. The first rotating device 20 a is configured to carry and rotate the to-be-inspected object 200a.

The reflecting device 30a is disposed in the vacuum inspection space 14a and connected to the first housing portion 11a. The reflecting device 30a is configured to receive the inspection light X reflected from the to-be-inspected object 200a, and further reflect the inspection light X toward the light output hole 15a along the axial direction of the light output hole 15a.

The inspection device 40a is disposed outside the first housing portion 11a and in alignment with the axial direction of the light output hole 15a, so as to receive the inspection light X reflected by the reflecting device 30a. Therein, the inspection device 40a may be hermetically mounted to the light output hole 15a via a hermetic connecting device (such as a flange), thereby maintaining the vacuum environment of the vacuum inspection space 14a.

Referring to FIG. 5, in another embodiment, the inspection light X is an EUV light. A light input hole 16a penetrates the periphery of the second housing portion 13 a, and a laser device 50a for generating the inspection light X is disposed outside the second housing portion 13a and in alignment with the light input hole 16a. The inspection light X passes through the light input hole 16 a into the vacuum inspection space 14a and is projected onto the to-be-inspected object 200a. Accordingly, the laser device 50a disposed outside the vacuum rotating housing 10a facilitates adjustment and maintenance carried out by the user. Therein, the inspection light X may also be visible light, infrared light, X-rays, UV light, or other light suitable for optical inspection. The laser device 50a is configured to be hermetically connected to the light input hole 16a via a hermetic connecting device (such as a flange), thereby maintaining the vacuum environment of the vacuum inspection space 14a.

It should be noted that, in the second embodiment, the laser device 50a generating the inspection light X is disposed in the vacuum inspection space 14a or in another vacuum space in communication with the vacuum inspection space 14a. The inspection light X output by the laser device 50a is directly projected onto the to-be-inspected object 200 a without the arrangement of the light input hole 16a.

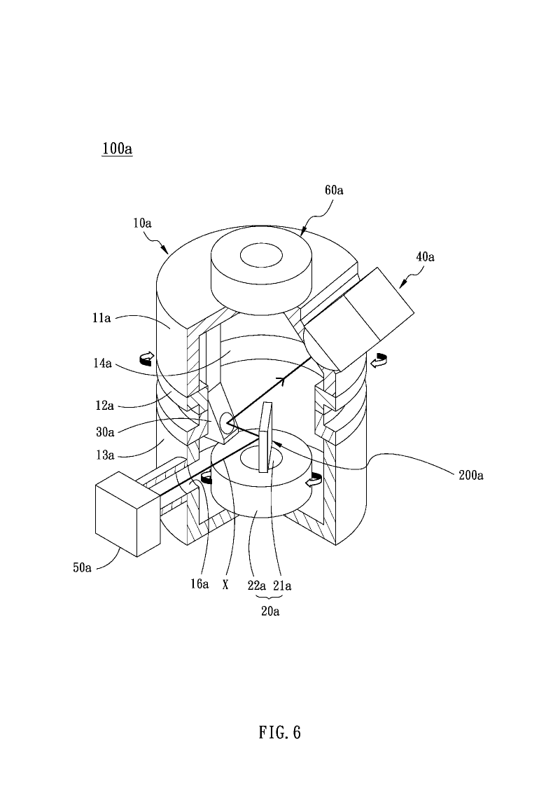

Referring to FIGS. 5 and 6, in another embodiment, the first rotating device 20a comprises a carrier 21a and a first rotating member 22a. The carrier 21a is connected and disposed at the center of the first rotating member 22a, and the carrier 21a is configured to carry the to-be-inspected object 200 a. The first rotating member 22a is configured to drive the carrier 21a to rotate. Specifically, the first rotating member 22a is used to rotate the carrier 21a so as to correspondingly rotate the to-be-inspected object 200a, such that the inspection light X is projected onto the to-be-inspected object 200 a at different incident angles while maintaining a fixed incident position. Therefore, the inspection device 40a is able to obtain multiple sets of inspection data at different angles for the same inspection region of the to-be-inspected object 200a and accordingly perform the analysis, so as to obtain complete inspection information of the to-be-inspected object 200a of the aforementioned inspection region.

In addition, by directly moving the to-be-inspected object 200a or adjusting the overall position of the first rotating device 20a, the inspection light X can be projected onto different inspection regions of the to-be-inspected object 200 a, thereby enabling the inspection device 40a to obtain inspection data of the to-be-inspected object 200a at different inspection regions.

It should be noted that, during actual operation of the present disclosure, the rotation angle of the first housing portion 11a is twice the rotation angle of the first rotating member 22a. For example, when the first rotating member 22a rotates by two degrees, the first housing portion 11a rotates by four degrees. Accordingly, the reflecting device 30a is able to accurately receive the inspection light X reflected from the to-be-inspected object 200a and further accurately reflect the inspection light X to the inspection device 40a.

Referring to FIG. 6, in another embodiment, the reflecting device 30a comprises a first reflecting portion 31a and a specular reflecting portion 32a, which are symmetrically disposed. The specular reflecting portion 32a has the same specifications as the first reflecting portion 31a. The inspection light X reflected from the to-be-inspected object 200a is further reflected by the first reflecting portion 31a and the specular reflecting portion 32a along the respective reflection paths and then projected onto the inspection device 40a. Accordingly, through the aforementioned symmetrical configuration, reflecting elements of the first reflecting portion 31a and the specular reflecting portion 32a can be selected to have identical specifications, thereby further reducing the setup costs of the overall system. Therein, the travel paths of the inspection light X through the first reflecting portion 31a and the specular reflecting portion 32a are perpendicularly paths.

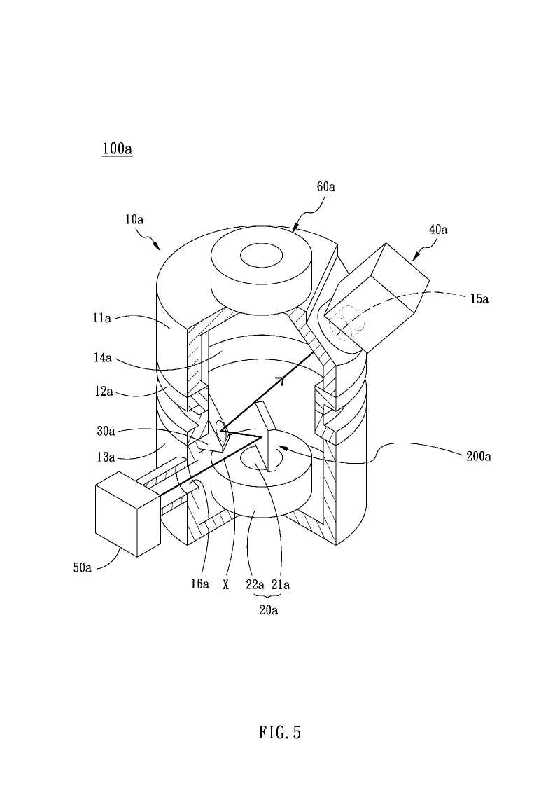

Referring to FIG. 7, the inspection device 40a is disposed outside the first housing portion 11a along a horizontal direction parallel to the ground surface. Accordingly, the inspection light X reflected by the specular reflecting portion 32a travels to the inspection device 40a along the shortest path, thereby further reducing loss of the inspection light X and maintaining high inspection accuracy of the to-be-inspected object 200a.

Referring to FIGS. 5 and 6, in the second embodiment, the vacuum environment optical inspection system 100a further comprises a second rotating device 60a. The second rotating device 60a is disposed at an outer periphery of the first housing portion 11a and is configured to control the rotation of the first housing portion 11a relative to the second housing portion 13a. Accordingly, the user can rotate the first housing portion 11a relative to the second housing portion 13a manually using the second rotating device 60a. Alternatively, when the second rotating device 60a is equipped with a power source (e.g., electric power), the user can perform the relative rotation of the first housing portion 11a using either a remote control or an automatic operation method.

With the foregoing configuration, the present disclosure achieves following technical advantages.

Through the coordinated arrangement of the first rotating device 20, the second rotating device 30, and the reflecting device 40, the travel path of the inspection light L is precisely controlled, and the output position of the inspection light L is standardized, such that the inspection device 50 is fixed and arranged outside the vacuum inspection space 11, thereby significantly reducing the size of the vacuum inspection space 11 and lowering the installation cost of the inspection device 50, while maintaining a high inspection accuracy. As a result, the overall system installation and maintenance costs are reduced.

Through the special symmetrical configuration of the reflecting device 40, the reflecting elements can be selected to have identical specifications in order to form the reflecting device 40, further reducing the overall system setup cost.

By coaxially stacking the first rotating device 20 and the second rotating device 30, the reflecting device 40 is effectively moved and rotated about the to-be-inspected object 200, thereby reducing setup complexity while maintaining the system stability.

Through the vacuum rotating housing 10 a in combination with the direct arrangement of the reflecting device 30 a, the requirement of vacuum components is further reduced, thereby effectively lowering the system installation and maintenance costs.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A vacuum environment optical inspection system for optically inspecting a to-be-inspected object, the vacuum environment optical inspection system comprising:
a housing having a vacuum inspection space and a light output hole, the light output hole penetrating a periphery of the housing and in communication with the vacuum inspection space, an inspection light being output through the light output hole after completing light path transmission within the vacuum inspection space;
a first rotating device disposed in the vacuum inspection space, the first rotating device being configured to carry and rotate the to-be-inspected object, the inspection light being projected onto the to-be-inspected object and reflected therefrom;
a second rotating device disposed in the vacuum inspection space;
a reflecting device connected to the second rotating device and configured to rotate about the to-be-inspected object to receive the inspection light reflected from the to-be-inspected object, and to further reflect the inspection light toward the light output hole along an axial direction of the light output hole; and
an inspection device disposed outside the housing and in alignment with the axial direction of the light output hole to receive the inspection light reflected by the reflecting device.

2. The vacuum environment optical inspection system of claim 1, wherein the inspection light is an extreme ultraviolet light; a light input hole penetrates the periphery of the housing and is in communication with the vacuum inspection space; a laser device configured to generate the inspection light is disposed outside the housing and arranged in alignment with the light input hole.

3. The vacuum environment optical inspection system of claim 1, wherein the inspection light is an extreme ultraviolet light; a laser device configured to generate the inspection light is disposed in the vacuum inspection space.

4. The vacuum environment optical inspection system of claim 1, wherein the first rotating device comprises a carrier and a first rotating member; the carrier is connected and disposed at a center of the first rotating member, and configured to carry the to-be-inspected object; the first rotating member is configured to drive the carrier to rotate; the second rotating device is coaxially stacked on the first rotating device; the second rotating device comprises a coupling member, a second rotating member, and a mounting hole; the coupling member is disposed between the second rotating member and the first rotating member, such that the first rotating member and the second rotating member are rotatable relative to each other via the coupling member; the mounting hole penetrates a center of the coupling member and the second rotating member, and enables the carrier to pass therethrough.

5. The vacuum environment optical inspection system of claim 1, wherein the second rotating device has a supporting surface; the reflecting device comprises a first reflecting member and a second reflecting member; the first reflecting member and the second reflecting member are respectively disposed on two sides of the supporting surface; the first reflecting member is configured to receive the inspection light reflected from the to-be-inspected object and further reflect the inspection light to the second reflecting member; the second reflecting member is configured to receive the inspection light reflected from the first reflecting member and further reflect the inspection light toward the light output hole along the axial direction of the light output hole.

6. The vacuum environment optical inspection system of claim 5, wherein the light output hole and the inspection device are disposed directly above the to-be-inspected object; the second reflecting member is configured to reflect the inspection light to the inspection device along a vertical direction perpendicular to a ground surface.

7. The vacuum environment optical inspection system of claim 5, wherein the first reflecting member comprises a first reflecting portion and a specular reflecting portion, which are symmetrically disposed; the specular reflecting portion is configured to have same specifications as the first reflecting portion; the inspection light reflected from the to-be-inspected object is further reflected by the first reflecting portion and the specular reflecting portion along respective reflection paths thereof and then projected onto the second reflecting member.

8. A vacuum environment optical inspection system for optically inspecting a to-be-inspected object, the vacuum environment optical inspection system comprising:
a vacuum rotating housing having a first housing portion, a connecting portion, and a second housing portion, the connecting portion connected between the first housing portion and the second housing portion and forming a vacuum inspection space, the first housing portion and the second housing portion being configured to be relatively rotatable via the connecting portion, a light output hole penetrating a periphery of the first housing portion, an inspection light being generated within the vacuum inspection space and projected onto the to-be-inspected object located in the vacuum inspection space;
a first rotating device connected to the second housing portion and disposed in the vacuum inspection space, the first rotating device being configured to carry and rotate the to-be-inspected object;
a reflecting device disposed in the vacuum inspection space and connected to the first housing portion, the reflecting device being configured to receive the inspection light reflected from the to-be-inspected object and to further reflect the inspection light toward the light output hole along an axial direction of the light output hole; and
an inspection device disposed outside the first housing portion and in alignment with the axial direction of the light output hole to receive the inspection light reflected by the reflecting device.

9. The vacuum environment optical inspection system of claim 8, wherein the inspection light is an extreme ultraviolet light; a light input hole penetrates a periphery of the second housing portion; a laser device configured to generate the inspection light is disposed outside the second housing portion and arranged in alignment with the light input hole.

10. The vacuum environment optical inspection system of claim 8, wherein the inspection light is an extreme ultraviolet light; a laser device configured to generate the inspection light is disposed in the vacuum inspection space.

11. The vacuum environment optical inspection system of claim 8, wherein the first rotating device comprises a carrier and a first rotating member; the carrier is connected and disposed at a center of the first rotating member, and configured to carry the to-be-inspected object; the first rotating member is configured to drive the carrier to rotate.

12. The vacuum environment optical inspection system of claim 8, wherein the reflecting device comprises a first reflecting portion and a specular reflecting portion, which are symmetrically disposed; the specular reflecting portion is configured to have same specifications as the first reflecting portion; the inspection light reflected from the to-be-inspected object is further reflected by the first reflecting portion and the specular reflecting portion along respective reflection paths thereof and then projected onto the second reflecting member.

13. The vacuum environment optical inspection system of claim 8, wherein the inspection device is disposed outside the first housing portion along a horizontal direction parallel to a ground surface.

14. The vacuum environment optical inspection system of claim 8, wherein the vacuum environment optical inspection system further comprises a second rotating device; the second rotating device is disposed at an outer periphery of the first housing portion, and is configured to control rotation of the first housing portion relative to the second housing portion.
